(19) United States
(12) Patent Application Publication
(10) Pub. No.: US 2023/0305805 A1
(43) Pub. Date: Sep. 28, 2023

(54) CHAINED MULTIPLY ACCUMULATE USING AN UNROUNDED PRODUCT

(71) Applicant: Arm Limited, Cambridge (GB)

(72) Inventors: Harsha VALSARAJU, Austin, TX (US); David Raymond LUTZ, Austin, TX (US); Javier Diaz BRUGUERA, Cambridge (GB)

(21) Appl. No.: 17/700,911

(22) Filed: Mar. 22, 2022

(51) Int. Cl. G06F 7/544; G06F 7/485; G06F 7/487; G06F 9/30; G06F 9/38

(52) U.S. Cl. CPC G06F 7/5443; G06F 7/485; G06F 7/487; G06F 9/30145; G06F 9/3893

(57) ABSTRACT

Apparatus, method and non-transitory computer-readable medium to store computer-readable code for fabrication of an apparatus. The apparatus comprises instruction decode circuitry to decode instructions and processing circuitry to execute the instructions decoded by the instruction decode circuitry. The processing circuitry comprises chained-floating-point-multiply-accumulate circuitry responsive to a chained-floating-point-multiply-accumulate instruction decoded by the instruction decoder, the chained-floating-point-multiply-accumulate instruction specifying a first floating-point operand, a second floating-point operand and a third floating-point operand, to: generate an unrounded product based on multiplying the first floating-point operand and the second floating-point operand; generate a first rounding increment based on the unrounded product; generate a sum based on adding the unrounded product, a value based on the first rounding increment, and the third floating-point operand; determine a second rounding increment based on the sum; and perform rounding based on the second rounding increment.

### TECHNICAL FIELD

The present technique relates to the field of data processing systems.

### BACKGROUND

A multiply-accumulate (MAC) operation involves multiplying together two operands (e.g. multiplicands) and then adding a third operand (e.g. an addend). Such an operation can be represented as:

(a×b)+c,

where a and b are the multiplicands and c is the addend.

A MAC operation involving three floating-point (FP) operands can be performed by a chained multiply accumulate (CMAC) unit, which computes the product of the multiplicands and rounds the product, before adding the addend to the rounded product and rounding the result.

### SUMMARY

Viewed from one example, the present technique provides an apparatus comprising:
instruction decode circuitry to decode instructions; and
processing circuitry to execute the instructions decoded by the instruction decode circuitry,
wherein the processing circuitry comprises chained-floating-point-multiply-accumulate circuitry responsive to a chained-floating-point-multiply-accumulate instruction decoded by the instruction decoder, the chained-floating-point-multiply-accumulate instruction specifying a first floating-point operand, a second floating-point operand and a third floating-point operand, to:
   generate an unrounded product based on multiplying the first floating-point operand and the second floating-point operand;
   generate a first rounding increment based on the unrounded product;
   generate a sum based on adding the unrounded product, a value based on the first rounding increment, and the third floating-point operand;
   determine a second rounding increment based on the sum; and
   perform rounding based on the second rounding increment.

Viewed from another example, the present technique provides a method comprising:
decoding instructions with instruction decode circuitry;
executing the instructions decoded by the instruction decode circuitry,
in response to a chained-floating-point-multiply-accumulate instruction decoded by the instruction decoder, the chained-floating-point-multiply-accumulate instruction specifying a first operand, a second operand and a third operand:
   generating an unrounded product based on multiplying the first operand and the second operand;
   generating a first rounding increment based on the unrounded product;
   generating a sum based on adding the unrounded product, a value based on the first rounding increment, and the third operand;
   determining a second rounding increment based on the sum; and
   performing rounding based on the second rounding increment.

Viewed from another example, the present technique provides a non-transitory computer-readable medium to store computer-readable code for fabrication of an apparatus comprising:
instruction decode circuitry to decode instructions; and
processing circuitry to execute the instructions decoded by the instruction decode circuitry,
wherein the processing circuitry comprises chained-floating-point-multiply-accumulate circuitry responsive to a chained-floating-point-multiply-accumulate instruction decoded by the instruction decoder, the chained-floating-point-multiply-accumulate instruction specifying a first operand, a second operand and a third operand, to:
   generate an unrounded product based on multiplying the first operand and the second operand;
   generate a first rounding increment based on the unrounded product;
   generate a sum based on adding the unrounded product, a value based on the first rounding increment, and the third operand;
   determine a second rounding increment based on the sum; and
   perform rounding based on the second rounding increment.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates a system comprising a CPU and a GPU sharing access to memory;

FIG. 2 schematically illustrates components within a processing element, including CMAC circuitry;

FIG. 3 illustrates how a number may be represented in floating-point format;

FIG. 4 schematically illustrates an example of a CMAC unit;

FIG. 5 schematically illustrates an example of a fused multiply-accumulate (FMA) unit;

FIG. 6 schematically illustrates an example of CMAC circuitry;

FIG. 7 illustrates processes performed within an example CMAC unit;

FIG. 8 illustrates the processes performed within an example CMAC unit; and

FIG. 9 is a flow diagram illustrating a method of executing a chained-multiply-accumulate instruction using CMAC circuitry.

### DESCRIPTION OF EXAMPLES

Before discussing example implementations with reference to the accompanying figures, the following description of example implementations and associated advantages is provided.

In accordance with one example configuration there is provided an apparatus comprising instruction decode circuitry (e.g. an instruction decoder or instruction decode unit) to decode instructions, and processing circuitry to execute the instructions decoded by the instruction decode circuitry. The processing circuitry comprises chained-floating-point-multiply-accumulate (CMAC) circuitry responsive to a chained-floating-point-multiply-accumulate (CMAC) instruction decoded by the instruction decoder, the chained-floating-point-multiply-accumulate instruction specifying a first floating-point (FP) operand, a second floating-point operand and a third floating-point operand, and the CMAC circuitry being responsive to the CMAC instruction to:
generate an unrounded product based on multiplying the first floating-point operand and the second floating-point operand;
generate a first rounding increment based on the unrounded product;
generate a sum based on adding the unrounded product, a value based on the first rounding increment, and the third floating-point operand;
determine a second rounding increment based on the sum; and
perform rounding based on the second rounding increment.

The present technique describes a CMAC unit which performs a MAC operation using three floating point (FP) operands, each of which may, for example, comprise a sign, a mantissa (or fraction/significand) and an exponent. For example, a FP operand may take the form:

±mantissa×2^{exponent}

The CMAC circuitry of the present technique generates a result of a multiply-accumulate operation.

As noted above, an approach to performing multiply-accumulate operations is to use a CMAC unit. A CMAC unit performs a “chained” multiply-accumulate operation involving computing the product of the multiplicands (e.g. the first and second FP operands) and rounding the computed product, before adding the addend (e.g. the third FP operand) to the rounded product and rounding the result—“chained” refers to the fact that the multiply and the add are performed one after the other.

However, the CMAC process performed by conventional CMAC units can be slow, especially in the multiplier stage. This is due, in part, to the fact that rounding is a lengthy process. In particular, the first rounding step can be slow because it normally would be done by adding a rounding increment to the computed product using a carry propagate adder. The slowness of the CMAC process can then limit the overall performance of a data processing apparatus in which a CMAC unit is implemented, e.g. because of reduced throughput of instructions due to increasing the duration of a clock cycle (for example), and/or delaying any operations which rely on the result of the CMAC operation.

To address this problem, the present technique provides CMAC circuitry which generates an unrounded product of two FP operands and a rounding increment, and adds together the unrounded product, a value based on the first rounding increment, and a third FP operand. Hence, instead of rounding the product of the first and second FP operands and then separately adding the third FP operand, the product is effectively rounded at the same time as adding the third FP operand, and the rounding of the product does not need to delay preliminary steps for preparing for addition of the third FP operand. This leads to a significant reduction the time taken to perform the CMAC operation which, in turn, leads to an improvement in the performance of the apparatus as a whole. In particular, delaying the first rounding operation allows the addition operation to begin sooner. Moreover, performing the first rounding operation by adding a value based on the rounding increment to the unrounded product and the third FP operand is quicker than separately rounding the product and then performing the addition.

The first, second and third FP operands can be specified by the CMAC instruction in any of a number of ways; for example, the FP operands may be held in FP registers, and the CMAC instruction may identify the FP registers holding the three FP operands. However, it will be appreciated that the way in which the FP operands are specified is a matter of implementation, and other techniques can also be used.

In some examples, the chained-floating-point-multiply-accumulate (CMAC) circuitry is configured to align the unrounded product and the third floating-point (FP) operand before generating the sum based on adding the unrounded product, the value based on the first rounding increment, and the third floating-point operand.

In a conventional CMAC operation (e.g. where the product of the first and second FP operands is rounded before adding the third FP operands), one would expect that this alignment of the mantissas of the product and third operand could not be performed until after rounding the unrounded product (e.g. after adding the first rounding increment to the unrounded product). However, in examples of the present technique, this alignment of the mantissas can start without waiting for the first rounding increment to have been added to the unrounded product, because it is the unrounded product which is added to the third FP operand in the present technique, rather than adding the rounded product to the third FP operand as in a conventional CMAC process. This shortens the critical path latency, and hence leads to an improvement in performance.

In some examples, the chained-floating-point-multiply-accumulate (CMAC) circuitry is configured to generate the unrounded product in an un-normalized form and, before aligning the unrounded product and the third floating-point (FP) operand, append an additional bit at a most significant end of a mantissa of the third floating-point operand to align a binary point position of the third floating-point operand with a binary point position of the unrounded product. The additional bit may have a bit value of 0 (1′b0). This additional bit is a further bit separate from an implicit leading bit of the mantissa, not represented in the stored form of the third floating-point operand, which is also appended to the stored fractional bits of the mantissa. The implicit leading bit has a value of 1′b1 and the additional bit of 1′b0 appended to align the third floating-point operand with the unrounded product is appended at a bit position more significant than the implicit leading bit. Hence, relative to the stored fractional bits of the third floating-point operand, two bits are appended having value 2′b01.

FP operands can be normalized, so that they have a “1” as their leading bit, and the binary point is assumed to immediately follow their leading bit. For example, a normalized FP operand may have the form:

±1.xxx×2^{exponent}

where “1.xxx” is the mantissa, and the “x”s can take any value. Note that when the FP number is stored, the leading 1 in the mantissa is often considered to be implicit.

In a typical CMAC unit, the rounded product output generated after multiplying the first and second FP operands may be normalized as well as rounded. However, in examples of the present technique, the unrounded product generated based on adding the first and second FP operands may be in an un-normalized form (e.g. the leading bit might not necessarily be a “1”, and/or the binary point position might not necessarily follow the leading bit). One might expect this to complicate the addition of the unrounded product, the third FP operand and the value based on the first rounding increment, since the third FP operand may be represented in a normalized form, and hence its binary point may be in a different position in the mantissa to that of the unrounded, un-normalized product. However, this discrepancy can be avoided by appending additional bits at a most significant end of the mantissa of the third FP operand to align a binary point position of the third floating-point operand with a binary point position of the unrounded product. As discussed further below, this approach is particularly effective in examples which flush subnormal multiplication results to zero, because in this case any non-zero multiplication results can only have the leading ‘1’ bit in one of two unrounded bit positions, which reduces the number of options needed for alignment with the third FP operand.

In some examples, the chained-floating-point-multiply-accumulate (CMAC) circuitry is configured to align the unrounded product and the third floating-point operand based on an exponent difference, wherein the exponent difference has a value corresponding to

exponent difference=|a_exp+b_exp−bias−expc|

wherein a_exp is an exponent of the first floating-point operand, b_exp is an exponent of the second floating point operand, expc is an exponent of the third floating point operand, and bias is an implicit bias applied to each of a_exp, b_exp and expc. The vertical lines ∥ in the expression above indicate that the modulus of the expression is taken.

The expression

expp=a_exp+b_exp−bias

represents the (biased) exponent (expp) of a product of multiplying the first FP operand and the second FP operand, without rounding the product—e.g. expp is an exponent associated with the unrounded product. Note that the “bias” term represents an implicit bias associated with each of the exponents of the first, second and third FP operands. In this case, it is assumed that the exponents of all three FP operands are represented using the same bias. For example, while the (biased) exponents may be represented as a_exp, b_exp, expc and expp, the true (unbiased) exponents of the first, second and third FP operands and the exponent associated with the unrounded product may be:
a_exp−bias;
b_exp−bias;
expc−bias; and
expp−bias.

Hence, the above expression for expp can be derived as follows:

true (unbiased)expp=(aₑₓₚ−bias)+(bₑₓₚ−bias)=a_exp+b_exp−2×bias

∴(biased)expp=aₑₓₚ+bₑₓₚ−2×bias+bias=a_exp+b_exp−bias

This leads to the above expression for the (biased) exponent difference, repeated below:

exponent difference=|a_exp+b_exp−bias−expc|

It will be appreciated that if the exponents are represented in an un-biased form, then the “bias” term can simply be set to zero and the above expression would still be correct.

In some examples, the chained-floating-point-multiply-accumulate (CMAC) circuitry is configured to increment, after calculating the exponent difference, either the exponent associated with the unrounded product or the exponent of the third floating-point operand.

When adding two FP operands, the exponent of the result is typically determined by selecting one (typically the larger) of the exponents of the addends (and potentially performing an adjustment of the exponent due to a normalization shift at the end of the process if there was a carry out in the addition or there are leading zeroes in the result of an unlike signed addition); this is also true of the addition performed in a conventional CMAC operation. However, in examples of the present technique, the selected exponent is also incremented (e.g. in addition to any normalization shift which may subsequently occur). This is to account for the fact that the unrounded product is un-normalized, and hence is in the form XX.xxxx (e.g. instead of in the form 1.xxxx, as expected for a normalized mantissa), and the addend (e.g. the third FP operand) has been appended with extra bits to match this form XX.xxxx.

In a conventional CMAC operation, instead of incrementing the selected exponent as in the above example of the present technique, the exponent associated with the product would already have been incremented prior to calculating the exponent difference, at the point of normalizing the unrounded product. In contrast, the present technique allows this increment of the exponent to be delayed until after calculating the exponent difference, which shortens critical path latency by taking the increment off the critical timing path (e.g. since the alignment shift based on the exponent difference (and hence the add of the product to the addend) can start earlier the exponents). Therefore, delaying the increment until after calculating the exponent difference allows the performance of the apparatus to be further improved.

In some examples the chained-floating-point-multiply-accumulate (CMAC) circuitry is configured to generate the unrounded product in an un-normalized form, generate an exponent difference based on an exponent associated with the unrounded product and an exponent of the third floating-point operand, and align the unrounded product and the third floating-point operand based on the exponent difference.

In this example, since the unrounded product is also un-normalized, the bit position of the leading “1” can vary—e.g. the leading bit of the unrounded, un-normalized product may be a 0 or a 1, and the binary point may not necessarily be positioned after the leading 1. Hence, one might expect that the exponent difference should be calculated based on the exponent generated after the unrounded product has been rounded and normalized. However, the inventors of the present technique realised that, by generating the exponent difference based on the exponent associated with the unrounded product, it is possible to start performing the addition part of the MAC operation earlier (since it is no longer dependent on the rounding and/or alignment processes). This, in turn, allows the entire MAC operation to be performed more quickly.

In some examples, the chained-floating-point-multiply-accumulate (CMAC) circuitry comprises floating-point-multiply (FMUL) circuitry and floating-point-add (FADD) circuitry, the floating-point-multiply circuitry is configured to generate the unrounded product and generate the first rounding increment, and the floating-point-add circuitry is configured to generate the sum based on adding the unrounded product, the value based on the first rounding increment, and the third floating-point operand, determine the second rounding increment and perform the rounding based on the second rounding increment.

In some examples, the floating-point-multiply (FMUL) circuitry comprises a first pipeline stage and the floating-point-add (FADD) circuitry comprises a second pipeline stage subsequent to the first pipeline stage.

The processing circuitry may comprise a processor pipeline made up of multiple pipeline stages. Each stage may receive data and/or instructions from a preceding stage, and may perform operations on the basis of the received data/instructions. For example, once one pipeline stage has completed its role in executing a given instruction, the next pipeline stage may begin its part in executing the given instruction. In this particular example of the present technique, the FMUL and FADD units are separate pipeline stages. The FMUL and FADD stages may be able to operate independently of one another—for example, this may mean that once the FMUL pipeline stage has finished its part in executing the CMAC instruction (e.g. by generating the unrounded product and the first rounding increment), the FADD pipeline stage can begin performing its function in respect of the CMAC instruction.

According to the present technique, unlike in a conventional CMAC unit, the rounding of the unrounded product based on the first rounding increment is delayed until the point of adding the addend (third FP operand). Hence, in this example, the rounding of the unrounded product is delayed until the FADD stage, making the FMUL operation faster (unlike in a conventional CMAC unit, where one would expect the first rounding of the product to take place in the FMUL stage).

One might think that moving the rounding of the unrounded product to the FADD stage in this way would not lead to an overall improvement in performance, since one might assume that the latency of the FADD stage would be increased by as much as the latency of the FMUL stage is decreased. However, the inventors realised that this would not necessarily be the case; since addition of three numbers (e.g. the unrounded product, the third FP operand and the value based on the first rounding increment) can be carried out using a 3:2 carry-save adder followed by a carry-propagate adder to add the carry and save outputs, which does not take longer than first performing an increment (to round the product) and then later performing an addition of two numbers (e.g. adding the rounded product to the third FP operand), which would require two separate carry-propagate adders. The deferral of the addition of the first rounding increment enables the alignment for the subsequent addition of the product and third operand to start earlier. Hence, performing the rounding based on the first rounding increment in the FADD stage rather than in the FMUL stage can lead to an overall improvement in performance.

In some examples, the apparatus comprises issue circuitry (e.g. an issue stage or an issue unit) to issue the instructions decoded by the instruction decode circuitry to the processing circuitry for execution, wherein when a first instance of the chained-floating-point-multiply-accumulate (CMAC) instruction and a second instance of the chained-floating-point-multiply-accumulate instruction are issued sequentially and input operands specified by the second instance of the chained-floating-point-multiply-accumulate instruction are independent of a result generated in response to the first instance of the chained-floating-point-multiply-accumulate instruction, the floating-point-multiply (FMUL) circuitry is configured to begin processing the second instance of the chained-floating-point-multiply-accumulate instruction while the floating-point-add (FADD) circuitry is processing the first instance of the chained-floating-point-multiply-accumulate instruction.

A feature of pipelining in processors can be that multiple instructions can be in execution at any given time, each at a different stage in the pipeline. For example, a given pipeline stage might begin executing the next instruction while subsequent pipeline stages execute previous instructions. In some examples, this is also the case for the FMUL and FADD units of the present technique—the FMUL unit is capable of beginning processing the next CMAC instruction while the FADD is still processing a previous CMAC instruction. This means that the first rounding increment (for rounding the unrounded product) of one instruction can be added in the FADD stage when the FMUL stage is already performing the multiply for the next instruction. This allows for an increased throughput of instructions which, in turn, allows the performance of the apparatus as a whole to be improved.

Moreover, in some examples a clocked storage element (e.g. flip-flop or latch) could be provided between the FMUL and FADD pipeline stages. The clocked storage element captures an indication of the first rounding increment as an output of the FMUL stage and inputs it to the FADD stage. This is counter-intuitive since, if the first rounding increment was added during the FMUL stage as in a conventional CMAC unit, one would not expect there to be any clocked storage element on the path between generating and adding the first rounding increment, as one would expect the rounding increment to be used in the same cycle it is generated and so it would only be the product that would be latched for operating on in a subsequent clock cycle (in the next pipeline stage).

In some examples, the chained-floating-point-multiply-accumulate (CMAC) circuitry is configured to determine the value based on the first rounding increment in dependence on at least one of: whether an exponent associated with the unrounded product is larger than an exponent of the third floating-point (FP) operand; and whether the sum based on adding the unrounded product, the value based on the first rounding increment, and the third floating-point operand represents a like-signed addition or an unlike-signed addition.

The value added to the unrounded product and the third FP operand is dependent on the first rounding increment, generated based on the unrounded product of multiplying the first and second FP operands. However, in some examples, this value is further dependent on whether an exponent (expp) associated with the unrounded product is larger than an exponent (expc) of the third floating-point operand (e.g. whether expp>expc, or whether expp<=expc). This allows the CMAC circuitry to take account of the fact that one of the unrounded product or the third FP operand may have been shifted in an alignment process. For example, depending on which of expp and expc is larger, the position at which the first rounding increment would need to be added to the lowest product bit may or may not contribute to the final rounded result—e.g. if the unrounded product is the smaller operand (e.g. if expp<expc), the rounding increment is added at a bit that would be shifted out of the result anyway (e.g. when aligning the unrounded product and the third FP operand), so it may not cause any change to the final result. Hence, in this example, the value based on the first rounding increment can account for this, by considering the relative size of the exponents expp and expc when setting the value based on the first rounding increment.

Alternatively, or in addition, the value based on the rounding increment may be dependent on whether the sum based on adding the unrounded product, the value based on the first rounding increment, and the third floating-point operand represents a like-signed addition or an unlike-signed addition—e.g. whether an odd number (unlike-signed) or an even-number/none (like-signed) of the first, second and third FP operands are negative. For example, for unlike signed additions a further increment may be performed to do a two's complement conversion, which may be considered in combination with the first rounding increment to avoid needing to add two additional values to the product and third operand.

In some examples, the chained-floating-point-multiply-accumulate (CMAC) circuitry is configured to align the unrounded product and the third floating-point (FP) operand before generating the sum based on adding the unrounded product, the value based on the first rounding increment, and the third floating-point operand, and the chained-floating-point-multiply-accumulate circuitry is configured to determine the value based on the first rounding increment in dependence on values of any shifted-out bits shifted, when aligning the unrounded product and the third floating-point operand, to bit positions less significant than a least significant bit position of a result value obtained by performing the rounding based on the second rounding increment.

Aligning two FP operands may involve shifting one or both of the mantissas of the FP operands a given number of bit positions to the left or to the right, in order to make their exponents the same (e.g. the mantissa of the FP operand with the smaller exponent is typically right-shifted, so that the lowest-order (least significant) bit(s) of its mantissa are lost). Hence, this can mean that some bits of the shifted operand(s) are “shifted out”, meaning that they are shifted to bit positions outside of the number of bits represented by the final result output by the CMAC circuitry. The inventors of the present technique recognised that these shifted-out bits may, in a typical CMAC unit, have influenced the rounding of the multiplication product of the first and second FP operands—e.g. as discussed above, if the exponent associated with the product is smaller than the exponent of the third FP operand, the shifted out bits would affect whether the rounding increment will cause any change to the upper bits that would contribute to the final result—and hence these bits are considered when performing the rounding during the addition of the unrounded product and the third FP operand.

In some examples, the chained-floating-point-multiply-accumulate circuitry is configured to select, as the value based on the first rounding increment, one of 0, 1 and 2.

This is counter-intuitive, since one would expect the value based on the first rounding increment to be 0 or 1 (and not 2)—e.g. rounding typically involves choosing between the FP numbers (of a given precision) to either side of a calculated value (having a greater precision), which would typically only require incrementing the value by 1 or 0 (e.g. at a given bit position). However, the inventors of the present technique realised that it might, at times, be useful to account for an extra increment implemented when calculating a two's complement during operation of the CMAC when an unlike signed addition is required because one of the product and third operand is negative and the other positive. This eliminates a need to perform a separate addition of the two's complement increment later. Hence, sometimes it can be useful to set the value based on the first rounding increment to 2 to account for adding both the first rounding increment and the two's complement increment.

In some examples, the apparatus comprises a central processing unit (CPU) or a graphics processing unit (GPU), wherein the central processing unit or the graphics processing unit comprises the processing circuitry.

Both CPUs and GPUs are processing elements comprising processing circuitry to execute instructions. A GPU may be a specialised processing element, specialising in performing processes related to creation of images. The present technique can be advantageous when used within either a CPU or a GPU (or any other type of processing element). However, the inventors realised that it can be particularly advantageous in a GPU to use CMAC units to perform multiply-accumulate operations, since any potential loss in accuracy due to performing two rounding operations might be acceptable because it may not be discernible in graphics generated by the GPU. Hence, the present technique can be particularly useful when implemented in a GPU, by offering better performance when compared with conventional CMAC units. Nevertheless, the technique can also be used in CPUs or other processing circuitry for performing a CMAC operation.

In some examples, the chained-floating-point-multiply-accumulate (CMAC) circuitry is configured to truncate the unrounded product before generating the sum.

By truncating the unrounded product (e.g. discarding any lower-order (less significant) bits after a given bit position), the circuitry used to perform the addition (e.g. generating the sum) can be made smaller (e.g. to take up less circuit area, allowing it to consume less dynamic power), since the number of bits to be considered in the addition is reduced. For example, this differs from the approach used in a fused-multiply-accumulate (FMAC) unit, where the product of the first and second FP operands would not be truncated, so that the addition circuitry for adding the product to the third FP operand would need to accommodate a much wider (e.g. more bits) addend than would be needed in the present technique. Hence, truncating the product as in this example allows for a reduction in circuit area and a reduction in power consumption when compared with, for example, a FMAC unit.

In some examples, the chained-floating-point-multiply-accumulate (CMAC) circuitry comprises a 3:2 carry save adder (CSA), and the chained-floating-point-multiply-accumulate circuitry is configured to generate the sum using the 3:2 carry save adder. The 3:2 carry save adder generates redundant terms: a sum term and a carry term. The CMAC circuitry may also comprise a subsequent carry-propagate adder to add the sum term and the carry term to produce a non-redundant output which is then optionally negated, normalized and rounded to product the result of the CMAC instruction.

In some examples, the chained-floating-point-multiply-accumulate (CMAC) circuitry is configured to output a result value equivalent to generating a product of the first floating-point (FP) operand and the second floating-point operand, then rounding the product, then adding the rounded product to the third floating-point operand to generate an unrounded sum, and then rounding of the unrounded sum to generate the result value.

Hence, the result output by the CMAC of the present technique may be equivalent to the result that would be output by a CMAC unit. The accuracy of MAC operations performed by the CMAC unit of the present technique is thus on par with that of a typical CMAC unit, but the time taken for the CMAC circuitry to generate a product is less than the time taken by a typical CMAC unit due to deferring the addition based on the first rounding increment (determined based on the product) until the product and addend are being added.

In some examples, when one or more of the first floating-point (FP) operand, the second floating-point operand and the third floating-point operand comprises a sub-normal floating point value, the chained-floating-point-multiply-accumulate (CMAC) circuitry is configured to treat the sub-normal floating point value as zero when processing the chained-floating-point-multiply-accumulate (CMAC) instruction.

A sub-normal FP value may be a FP number which cannot be represented without a leading zero in its mantissa—e.g. a sub-normal FP number may be smaller than the smallest FP number that can be represented in a normalized form with a leading 1 in its mantissa. The smallest normalized FP number depends on the floating point format being used—e.g. depending on the number of bits available for storing the exponent of the FP number. By setting any sub-normal input operands to zero in this way, the CMAC unit need not support sub-normal numbers, which allows the circuitry to be simplified and, in turn, reduces power consumption and circuit area, and helps to meet timing requirements. For example, by avoiding either the first or the second operand being a sub-normal number, one can ensure that a most significant bit (MSB) of the unrounded product will be in one of the top two bit positions. This, in turn, means that the unrounded product would only need to be shifted by 1 bit position in order to normalize it.

In some examples, the chained-floating-point-multiply-accumulate circuitry is configured to flush the unrounded product or a result value calculated by the chained-floating-point-multiply-accumulate circuitry to zero in response to determining that the unrounded product or the result value is too small to represent as a normalized floating-point number in a floating-point number to be used for the result value.

In a “flush-to-zero” mode of operation such as this, sub-normal values for the input operands, the intermediate value generated for the unrounded product, or the final MAC result are treated as zero even if they could have been represented as a sub-normal value (e.g. a FP number with a mantissa of the form 0.xxxx). This can simplify the CMAC circuitry, by avoiding the need for sub-normal numbers to be supported as the range of possible alignment scenarios may be reduced.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may be define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may embody computer-readable representations of one or more netlists. The one or more netlists may be generated by applying one or more logic synthesis processes to an RTL representation. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Particular examples will now be described with reference to the figures.

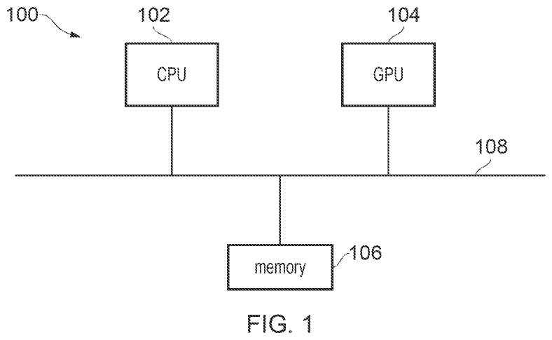

FIG. 1 schematically illustrates an example of a data processing system 100 comprising a CPU 102 and a GPU 104 in communication with a shared memory 106 via an interconnect 108. The CPU and GPU may each also be referred to as processing elements, processors, or cores, and each comprises processing circuitry to execute instructions. The instructions may be stored in memory 106, and the processing elements 102, 104 may be configured to perform operations on data stored in memory 106 when executing instructions.

The data processing system 100 comprises, in the processing circuitry of either the CPU or the GPU or both, an CMAC unit (also referred to herein as CMAC circuitry) to execute CMAC instructions. A CMAC instruction identifies three FP operands (e.g. a, b and c), and the CMAC unit is responsive to the CMAC instruction to determine a result corresponding to the expression (a*b)+c. Note that, in this application, the symbols ‘*’ and ‘x’ are used interchangeably to represent multiplication.

The GPU 104 is a processing element which specialises in (e.g. is specially adapted for) performing image processing operations (e.g. executing instructions to render images based on data stored in memory 106). In the GPU 104, high performance may be particularly important, since the GPU 104 may be processing a large amount of data in a relatively short amount of time (e.g. image processing operations performed by the GPU 104 may typically involve parallel processing (to operate on multiple data items at once—for example, images typically comprise a large amount of data (e.g. pixel data) that may need to be processed quickly). However, this desire for high performance can conflict with the desire to reduce power consumption and circuit cost within the GPU. It should also be noted that the competing desires for high performance and low power consumption and circuit cost are also relevant to CPU design.

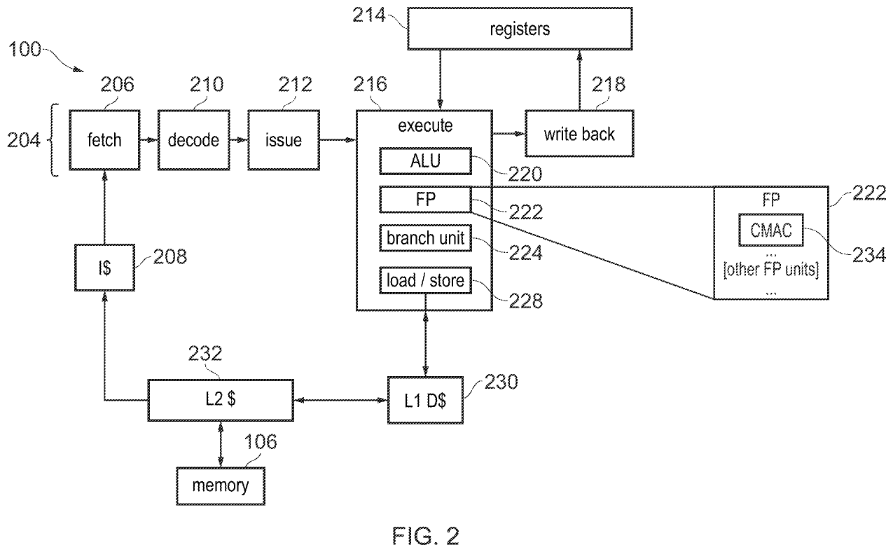

FIG. 2 schematically illustrates an example of components within a data processing apparatus 100 as shown in FIG. 1. The data processing apparatus 100 has a processing pipeline 204 which includes a number of pipeline stages. In this example, the pipeline stages include a fetch stage 206 (also referred to as fetch circuitry or a fetch unit) for fetching instructions from an instruction cache 208; a decode stage 210 (also referred to as decode circuitry or a decode unit) for decoding the fetched program instructions to generate micro-operations (e.g. decoded instructions) to be processed by remaining stages of the pipeline; an issue stage 212 (also referred to as issue circuitry or an issue unit) for checking whether operands required for the micro-operations are available in a register file 214 and issuing micro-operations for execution once the required operands for a given micro-operation are available; an execute stage 216 (also referred to as execution circuitry or an execute unit) for executing data processing operations corresponding to the micro-operations, by processing operands read from the register file 214 to generate result values; and a writeback stage 218 (also referred to as writeback circuitry or a writeback unit) for writing the results of the processing back to the register file 214. It will be appreciated that this is merely one example of possible pipeline architecture, and other systems may have additional stages or a different configuration of stages. For example in an out-of-order processor an additional register renaming stage could be included for mapping architectural registers specified by program instructions or micro-operations to physical register specifiers identifying physical registers in the register file 214. In some examples, there may be a one-to-one relationship between program instructions decoded by the decode stage 210 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 216 includes a number of processing units, for executing different classes of processing operation. For example the execution units may include an arithmetic/logic unit (ALU) 220 for performing arithmetic or logical operations; a floating-point (FP) unit 222 for performing operations on floating-point values, a branch unit 224 for evaluating the outcome of branch operations and adjusting the program counter which represents the current point of execution accordingly; and a load/store unit 228 for performing load/store operations to access data in a memory system 208, 230, 232, 106.

In this example, the FP unit 222 comprises an CMAC unit 234, for performing multiple-accumulate operations on FP values. More particularly, the CMAC unit 234 is responsive to chained-multiply-accumulate (CMAC) instructions decoded by the decode stage 210, the CMAC instructions specifying three FP operands (e.g. by identifying registers in the register file 214 holding those operands), to perform a chained multiply accumulate operation. The FP unit 222 may also include other circuitry (not shown) for performing different FP operations.

In this example the memory system includes a level one data cache 230, the level one instruction cache 208, a shared level two cache 232 and main system memory 106. It will be appreciated that this is just one example of a possible memory hierarchy and other arrangements of caches can be provided. The processing circuitry within each of the CPU 102 and the GPU 104 shown in FIG. 1 may comprise the processing pipeline 204 shown in FIG. 2, and the CPU and/or GPU may further comprise at least the registers 214 and the level 1 instruction and data caches 208, 230. The level 2 cache 232 may be outside of the CPU 102 and GPU 104—for example, a shared level 2 cache 232 may be provided in the interconnect 108—and may be shared between the CPU 124, the GPU 104 and, optionally, any further processing elements coupled to the interconnect 108. There may also be further levels of cache within each of the CPU 102 and/or GPU 104 (e.g. between the level 1 caches 208, 230 and what is currently identified as the level 2 cache 232).

The specific types of processing unit 220 to 228 shown in the execute stage 216 are just one example, and other implementations may have a different set of processing units or could include multiple instances of the same type of processing unit so that multiple micro-operations of the same type can be handled in parallel. It will be appreciated that FIG. 2 is merely a simplified representation of some components of a possible processor pipeline architecture, and the processor may include many other elements not illustrated for conciseness, such as branch prediction mechanisms or address translation or memory management mechanisms.

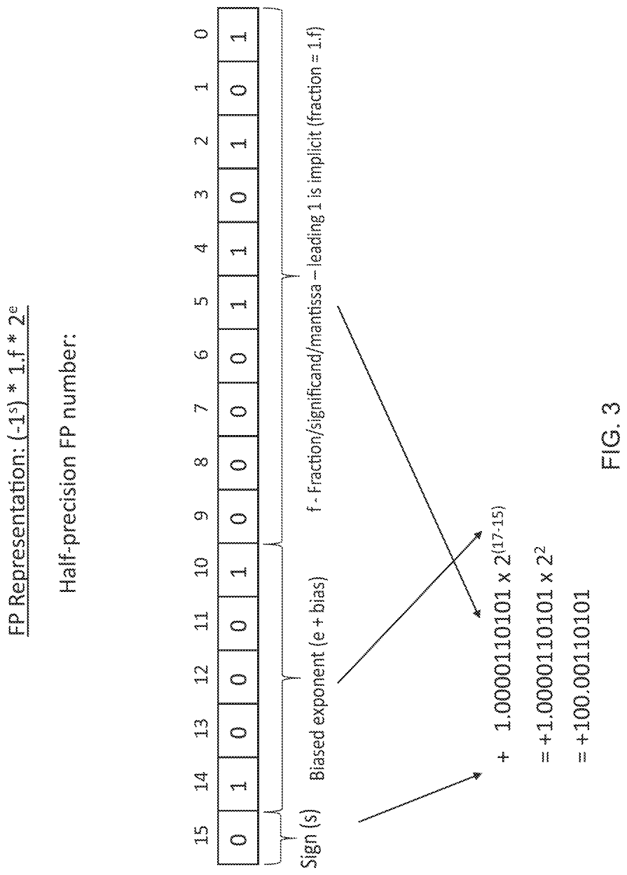

The present technique concerns operations performed on floating-point operands. FIG. 3 illustrates a floating-point (FP) representation of a number.

Floating-point (FP) is a useful way of approximating real numbers using a small number of bits. Multiple different formats for FP numbers have been proposed, including (but not limited to) binary 64 (also known as double precision, or DP), binary 32 (also known as single precision, or SP), and binary 16 (also known as half precision, or HP). The numbers 64, 32, and 16 refer to the number of bits required to represent FP numbers in each format. The example shown in FIG. 3 is a half precision FP number.

### Representation

FP numbers are quite similar to the “scientific notation” taught in science classes, where instead of negative two million one would write, in decimal, −2.0×10⁶. The parts of this number are the sign (in this case negative), the significand (2.0 in this case), the base of the exponent (10 in this case), and the exponent (6). All of these parts have analogs in FP numbers, although there are differences, the most important of which is that the constituent parts are stored as binary numbers, and the base of the exponent is always 2.

More precisely, FP numbers typically comprise a sign bit, some number of biased exponent bits, and some number of fraction (e.g. significand or mantissa) bits. For example, DP, SP and HP formats comprise the following bits, shown in Table 1:

TABLE 1

| format | sign | exponent | fraction | exponent bias |
|---|---|---|---|---|
| DP [63:0] | 63 | 62:52 (11 bits) | 51:0 (52 bits) | 1023 |
| SP [31:0] | 31 | 30:23 (8 bits) | 22:0 (23 bits) | 127 |
| HP [15:0] | 15 | 14:10 (5 bits) | 9:0 (10 bits) | 15 |

The sign is 1 for negative numbers and 0 for positive numbers. Every number, including zero, has a sign.

The exponent is biased, which means that the true exponent differs from the one stored in the number. For example, biased SP exponents are 8-bits long and range from 0 to 255. Exponents 0 and 255 (in SP) are typically special cases, but all other exponents have a bias of 127, meaning that the true exponent is 127 less than the biased exponent. The smallest biased exponent is, therefore, 1 (corresponding to a true exponent of −126), while the largest biased exponent is 254 (corresponding to a true exponent of 127). HP and DP exponents work the same way, with the biases indicated in the table above.

Exponent zero, in any of the formats, is typically reserved for subnormal numbers and zeros. A normal number represents the value:

(−1^{s})×1.f×2^{e}

where e is the true exponent computed from the biased exponent. The term 1.f is called the significand (or mantissa/fraction), and the leading 1 is not typically stored as part of the FP number, but is instead inferred from the exponent. All exponents except zero and the maximum exponent indicate a significand of the form 1.f (e.g. “f” is the part of the mantissa that is stored, while the leading 1 is implicit). The exponent zero indicates a significand of the form 0.fraction, and a true exponent that is equal to 1-bias for the given format. Such a number is called subnormal (historically these numbers were referred to as denormal, but modern usage prefers the term subnormal).

Numbers with both exponent and fraction equal to zero are zeros.

In the example shown in FIG. 3, a half-precision FP number is represented, using 16 bits. The left-most bit (bit 15—the bit positions are numbered from right to left, with the right-most bit being bit 0) represents the sign (s) of the FP number; in the example of FIG. 3, the sign is 0, indicating that the FP number is positive (note that it is also possible, in alternative implementations, for a sign bit of 0 to represent a negative sign, while a sign bit of 1 represents a positive sign). The next 5 bits (bits 14 to 10, inclusive) represent the biased exponent (e) of the number; in this example, the biased exponent is 0b10001, which is the number 17 in decimal. The true exponent of the number shown in FIG. 3 is, therefore, 2 (in decimal), since the bias is 15, and 17−5=2. Finally, bits 9 to 0 (inclusive) represent the mantissa. Note that the mantissa is preceded by an implicit “1.”, meaning that the mantissa in FIG. 3 is actually 1.0000110101 in binary.

Accordingly, the FP number represented in FIG. 3 can be determined as follows:

$$\begin{matrix}( - {1}^{s} ) \times 1 . f \times {2}^{e} \\ = + 1. 0000110101 \times {2}^{17 - 15} \\ = + 1. 0000110101 \times {2}^{2} \\ = + 10 \; 0.00110101\end{matrix}$$

Note that, for ease of explanation, the base (2), the biased exponent (17), the bias (15) and the true exponent (e) are represented in decimal format above and in FIG. 3.

The following table (Table 2) has some example numbers in HP format. The entries are in binary, with ‘_’ characters added to increase readability. Notice that the subnormal entry (4^{th} line of the table, with zero exponent) produces a different significand than the normal entry in the preceding line.

TABLE 2

| | 5-bit | | 11-bit significand | |
|---|---|---|---|---|
| sign | exponent | 10-bit fraction | (mantissa) | value |
| 0 | 01111 | 00_0000_0000 | 100_0000_0000 | 1.0 × 2⁰ |
| 1 | 01110 | 10_0000_0000 | 110_0000_0000 | −1.1 × 2⁻¹ |
| 0 | 00001 | 10_0000_0000 | 110_0000_0000 | 1.1 × 2⁻¹⁴ |
| 0 | 00000 | 10_0000_0000 | 010_0000_0000 | 0.1 × 2⁻¹⁴ |
| 1 | 11111 | 00_0000_0000 | | −infinity |
| 0 | 11111 | 00_1111_0011 | | NaN |

A large part of the complexity of FP implementation is due to subnormals, therefore they are often handled by microcode or software. However, it is also possible to handle subnormals in hardware, speeding up these operations by a factor of 10 to 100 compared to a software or microcode implementation.

### Two's Complement

The use of a sign bit to represent the sign (positive or negative) of a number, as in the FP representation, is called sign-magnitude, and it is different to the usual way integers are stored in the computer (two's complement). In sign-magnitude representation, the positive and negative versions of the same number differ only in the sign bit. A 4-bit sign-magnitude integer, consisting of a sign bit and 3 significand bits, would represent plus and minus one as:

+1=0001

−1=1001

Note that the left-most bit is reserved for the sign bit, so that 1001 represents the number −1, rather than the number 9.

In two's complement representation, an n-bit integer i is represented by the low order n bits of the binary n+1-bit value 2ⁿ+i, so a 4-bit two's complement integer would represent plus and minus one as:

+1=0001

−1=1111

In other words, a negative number is represented as the two's complement of the positive number of equal magnitude—for example, the two's complement of a number can be calculated by first calculating the one's complement (i.e. switching 1s to 0s and 0s to 1s) and adding 1. This is true for the above example—the one's complement of 0001 is 1110, and 1110+1=1111. The highest order bit is reserved, so that if it is a 1, this indicates that the number is negative (so that 1111 represents the number −1, and not 15). The two's complement format is practically universal for signed integers because it simplifies computer arithmetic.

### Rounding FP Numbers

Most FP operations are required by the IEEE-754 standard to be computed as if the operation were done with unbounded range and precision, and then rounded to fit into an FP number. If the computation exactly matches an FP number that can be accurately represented depending on the precision of the FP numbers (e.g. in SP, HP or DP), then that value is always returned, but usually the computation results in a value that lies between two consecutive floating-point numbers (e.g. the mantissa comprises more bits than can be represented in whichever precision is being used). Rounding is the process of picking which of the two consecutive numbers should be returned.

There are a number of ways of rounding, called rounding modes; the table below (Table 3) represents some of these.

TABLE 3

| | mode | definition |
|---|---|---|
| RNE | round-to nearest, | pick the closest value, or if both values are |
| | ties to even | equally close then pick the even value |
| RNA | round to nearest, | pick the closest value, or if both values are |
| | ties to away | equally close then pick the value farthest |
| | | away from zero |
| RZ | round to zero | pick the value closest to zero |
| RP | round to plus | pick the value closest to plus infinity |
| | infinity | |
| RM | round to minus | pick the value closest to minus infinity |
| | infinity | |
| RX | round to odd | pick the odd value |

However, the definition of any given rounding mode as shown in Table 3 does not explain how to round in any practical way. One common implementation is to do the operation, look at the truncated value (i.e. the value that fits into the FP format) as well as all of the remaining bits, and then adjust the truncated value if certain conditions hold. These computations are all based on:
L—(least)—the least significant bit of the truncated value;
G—(guard)—the next most significant bit (e.g. the first bit not included in the truncation); and
S—(sticky)—the logical OR of all remaining bits that are not part of the truncation.

Given these three values and the truncated value, we can compute the rounded value according to the following table (Table 4):

TABLE 4

| mode | change to the truncated value |
|---|---|
| RNE | increment if (L&G)\|(G&S) |
| RNA | increment if G |
| RZ | none |
| RP | increment if positive & (G\|S) |
| RM | increment if negative & (G\|S) |
| RX | set L if G\|S |

For example, consider multiplying two 4-bit significands, and then rounding to a 4-bit significand.

sig1=1011 (decimal 11)

sig2=0111 (decimal 7)

Multiplying sig1 by sig2 yields:

sig1×sig2=1001_101 (decimal 77)

The least significant bit of the truncated 4-bit result (L) is 1, the guard bit (G) is the next bit, so G=1, and S is the logical OR of the remaining bits after the guard bit (01)—so S=0|1=1. To round, we adjust our 4-bit result (1001) according to the rounding mode and the computation in Table 4 above. So for instance in RNA rounding, G is set (equal to 1) so we return 1001+1=1010. For RX rounding G|S is true so we set L to 1 (in this case, L is already 1, so nothing changes) and return 1001.

### Injection Rounding

A faster way to do rounding is to inject a rounding constant as part of the significand addition that is part of almost every FP operation. To see how this works, consider adding numbers in dollars and cents and then rounding to dollars. If we add

$1.27+$2.35=$3.62

We see that the sum $3.62 is closer to $4 than to $3, so either of the round-to-nearest modes should return $4. If we represented the numbers in binary, we could achieve the same result using the L, G, S method from the last section. But suppose we just add fifty cents and then truncate the result?

$1.27+$2.35+$0.50 (rounding injection)=$4.12

If we just returned the dollar amount ($4) from our sum ($4.12), then we have correctly rounded using RNA rounding mode. If we added $0.99 instead of $0.50, then we would correctly round using RP rounding. RNE is slightly more complicated: we add $0.50, truncate, and then look at the remaining cents. If the cents remaining are nonzero, then the truncated result is correct. If there are zero cents remaining, then we were exactly in between two dollar amounts before the injection, so we pick the even dollar amount. For binary FP this amounts to setting the least significant bit of the dollar amount to zero.

Adding three numbers is only slightly slower than adding two numbers, so we get the rounded result much more quickly by using injection rounding than if we added two significands, examined L, G, and S, and then incremented our result according to the rounding mode.

### Implementing Injection Rounding

For FP, the rounding injection is one of three different values, values which depend on the rounding mode and (sometimes) the sign of the result.
Both RNA and RNE require us to inject a 1 at the G position (this is like adding $0.50 in our dollars and cents example).
RP and RM rounding depends on the sign as well as the mode. RP rounds positive results up (increases the magnitude of the significand towards positive infinity), but truncates negative results (picking the significand that is closer to positive infinity). Similarly RM rounds negative results up (increasing the magnitude of the significand toward negative infinity), but truncates positive results (picking the significand that is closer to negative infinity). Thus we split RM and RP into two cases: round up (RU) when the sign matches the rounding direction, and truncation (RZ) when the sign differs from the rounding injection. For RU cases we inject a 1 at the G-bit location and at every location that contributes logically to S (this is like adding $0.99 in our dollars and cents example).
For RZ and RX modes, and for RP and RM modes that reduce to RZ mode, we inject zeros.

For most of the rounding modes, adding the rounding injection and then truncating gives the correctly rounded result. The two exceptions are RNE and RX, which require us to examine G and S after the addition. For RNE, we set L to 0 if G and S are both zero. For RX we set L to 1 if G or S are nonzero.

The present technique is particularly concerned with performing multiply-accumulate (MAC) operations on FP operands. As explained above, a MAC operation involves multiplying two FP operands (e.g. a*b, where a and b are FP operands, and may be referred to as the multiplicands) and adding a third FP operand to the product (e.g. adding a third FP operand c to the product a*b, e.g. (a*b)+c; the third FP operand c may be referred to as the addend). There are a number of ways in which such operations may be performed, with different techniques differing in terms of accuracy, complexity (and circuit area) and speed.

### FP Arithmetic

Generally, FP arithmetic is similar to arithmetic performed on decimal numbers written in scientific notation. For example, multiplying together two FP operands involves multiplying their mantissas and adding their exponents. For example:

a=(−1^{signa})×mantissaₐ×2^{expa}

b=(−1^{signb})×mantissa_{b}×2^{expb}

a×b=((−1^{signa})×mantissaₐ×2^{expa})×((−1^{signb})×mantissa_{b}×2^{expb})

a×b=(−1^{(signa+signb)})×(mantissaₐ×mantissa_{b})×2^{(expa+expb))}

Note that the terms “(−1^{signa})” and “(−1^{signb})” represent the sign (positive or negative) or each of the FP operands—for example, the sign bit (signa/signb) can be 0 or 1, so that if signa=1, for example, then the sign of operand a is negative (since −1¹=−1), whereas if signa=0, the sign of a is positive (since −1⁰=1).

Addition of two FP operands, on the other hand, involves manipulating one of the operands so that both operands have the same exponent, and then adding the mantissas. For example, consider adding the following FP operands:

a=1.11011×2²

b=1.00101×2³

The first step would be to select one of the exponents and adjust the other operand so that it has the same exponent. As noted above, it is more common to select the larger exponent. For example, if we select the larger exponent (3, which is the exponent of b) we need to shift the mantissa of the other FP operand (a) to the right by a number of places equal to the difference between the exponents (e.g. by 3−2=1). So:

a=1.11011×2²=0.111011×2³

We can then add the mantissas:

a+b=(0.111011+1.00101)×2³=1.111011×2³

MAC operations of the form (a*b)+c make use of the above principles.

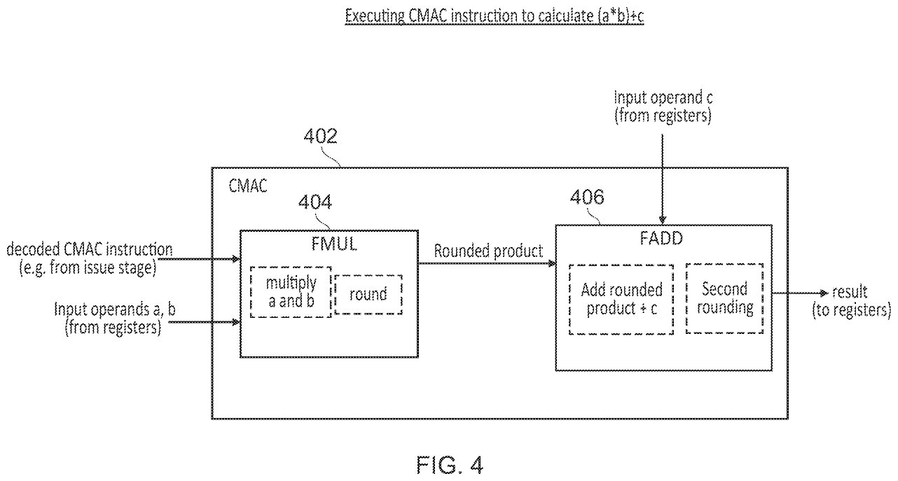

FIGS. 4 to 6 show various examples of circuitry which can be used to perform MAC operations of the form (a*b)+c. FIG. 4 shows a chained-multiply-accumulate (CMAC) unit 402, which comprises a floating-point-multiply (FMUL) unit 404 and floating-point-add (FADD) unit 406. The FMUL unit 404 is responsible for calculating the product (a*b) of the two multiplicands (a and b) and rounding the product, while the FADD unit 406—which is a separate pipeline stage—is responsible for generating the final result by adding the addend (c) to the product (a*b) and rounding the sum. In the CMAC unit 402, a MAC operation thus involves two separate rounding operations, since the FMUL unit 404 rounds the product before the FADD unit 406 adds the addend, and the FADD unit rounds the sum to generate the final result. Rounding and truncating the product to form a normalized/rounded floating-point value output from the FMUL stage 404 before generating the sum at the FADD stage 406 in this way can significantly reduce the circuit area taken up by the CMAC unit 402, since it reduces the number of bits that need to be considered in the addition performed by the FADD unit 406. However, performing two separate rounding operations can increase the time taken by the CMAC unit 402 to perform the MAC operation, since rounding can be a slow process. As a result, the overall performance of a data processing system implementing CMAC units might suffer, since the CMAC unit 402 might struggle to reach timing requirements of the system.

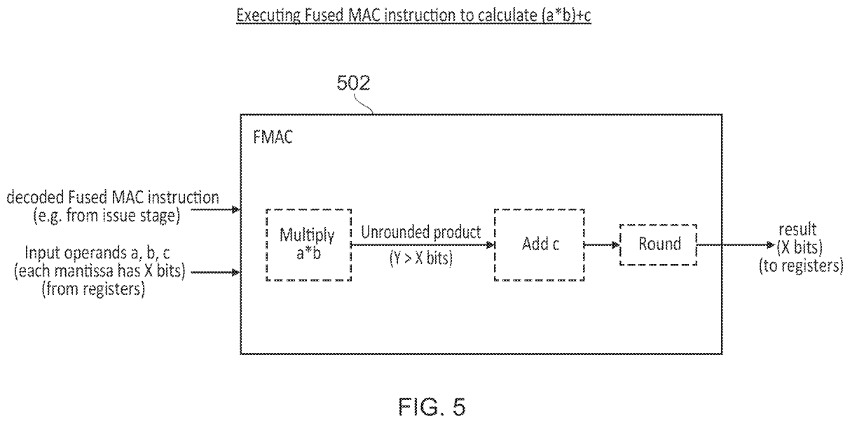

To address these issues, one might consider using a fused-multiply-accumulate (FMAC) unit 502 as shown in FIG. 5. In an FMAC unit, the product of the multiplicands a and b is not rounded, so that only a single rounding operation is performed, after adding the addend c. This leads allows a more accurate result to be calculated than would be possible with a CMAC unit, since the precision of the product a*b when calculating the sum (a*b)+c is greater (there is no intermediate truncation between the multiplication a*b and the addition of a*b+c). In addition, FMAC units such as the FMAC unit 502 of FIG. 5 are typically capable of generating a result more quickly than CMAC units, because the slow process of rounding is performed only once for rounding the final result. However, using the unrounded product in the addition means that a larger number of bits need to be considered, which can significantly increase the circuit area occupied by the FMAC unit 502 and the power consumption of the FMAC unit 502 when compared with a CMAC unit 402.

Hence, in situations where reducing cost in terms of circuit area and power consumption are considered more important than accuracy, a CMAC unit such as the CMAC unit 402 shown in FIG. 4 might be a better choice than an FMAC unit such as that shown in FIG. 5. For example, a difference in image quality of images rendered by a GPU employing CMAC units instead of FMAC units is often imperceptible to the human eye, and hence the reduction in accuracy caused by using CMAC units might be acceptable. However, the difficulty in reaching timing requirements when using a CMAC unit may still be an issue—for example, GPUs are typically expected to operate at high performance levels, given the amount of data that needs to be manipulated when rendering images. In another example, a CMAC unit might be useful in a CPU which prioritises low circuit area. However, even in cases where low circuit area is prioritised, it can still be useful to be able to improve performance, especially if this can be done without significantly increasing circuit area.

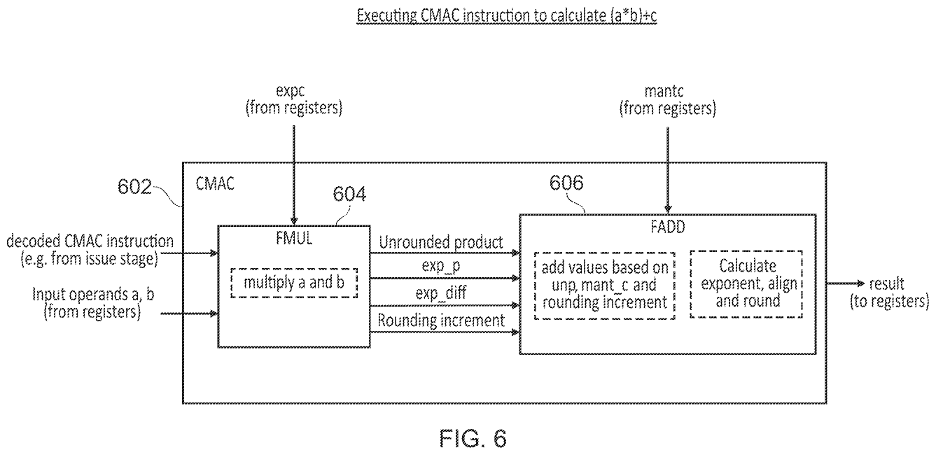

However, the present technique proposes a new type of CMAC unit, which provides the advantages of reduced circuit area and reduced power consumption when compared with an FMA unit, while also reducing the time taken to perform the multiply accumulate operation when compared with the CMAC unit of FIG. 4. An example of such a CMAC unit is shown in FIG. 6.

According to the present technique, a CMAC unit 602 is provided which, in the example of FIG. 6, comprises an FMUL unit 604 and an FADD unit 606. The operations performed by the FMUL unit 604 and the FADD unit 606 will be discussed in more detail below, but in general the FMUL unit 604 receives, as inputs, the multiplicands a and b and the exponent, expc, of the addend, and is responsible for generating an unrounded product of the multiplicands and a first rounding increment, and may also calculate an exponent associated with the unrounded product and an exponent difference between the exponent of the product and the exponent of the addend. The FMUL unit 604 does not, therefore, round the product it generates, but instead determines a first rounding increment which is provided to the FADD unit. Another difference between the CMAC circuitry 602 and the CMAC unit of FIG. 4 is that the calculation of the exponent difference is performed earlier (e.g. in the FMUL unit 604, rather than in the FADD unit 606). One might think that, since the exponent difference is needed for the FADD stage 606 and not the FMUL stage 604, there is no need to calculate the exponent difference so early. However, the inventors realised that in the CMAC unit 602 it is possible to calculate the exponent difference at this earlier stage, because the exponent difference can be computed from the input exponents of operands a, b, c and does not need to account for rounding/normalization of the product. This allows the alignment of the unrounded product and the third FP operand to begin earlier, which in turn reduces the latency associated with the process, thus improving performance. The FADD then generates a sum based on the mantissa of the addend, mantc, the first rounding increment and the unrounded product, unp. The FADD unit 606 then calculates a result, performs a second rounding, and outputs the rounded result.

Considering the first rounding increment when adding the unrounded product and the addend means that the result output by the CMAC unit 602 shown in FIG. 6 is equivalent to the result output by the CMAC unit 402 of FIG. 4—e.g. both CMAC units 403, 602 output a result equivalent to generating a product a*c, rounding (e.g. performing a first rounding of) the product, adding an addend c, and then performing a second rounding. However, because the first rounding is, in the CMAC unit 602 of FIG. 6, effectively performed at the same time as adding the unrounded product and the mantissa of the addend, the time taken to perform the multiply accumulate operation can be significantly reduced when compared with the CMAC unit 402 of FIG. 4. In particular, delaying the first rounding in this way allows the preliminary operations needed to perform the addition in the FADD stage (e.g. calculating the exponent difference, aligning the operands, etc.) can begin sooner (e.g. they do not have to wait until the product of the multiplicands has been rounded).

Accordingly, the CMAC unit 602 provides an alternative to an FMAC unit 502 which, in many implementations, still meets timing requirements, but offers reduced circuit area and reduced power consumption when compared with FMAC units.

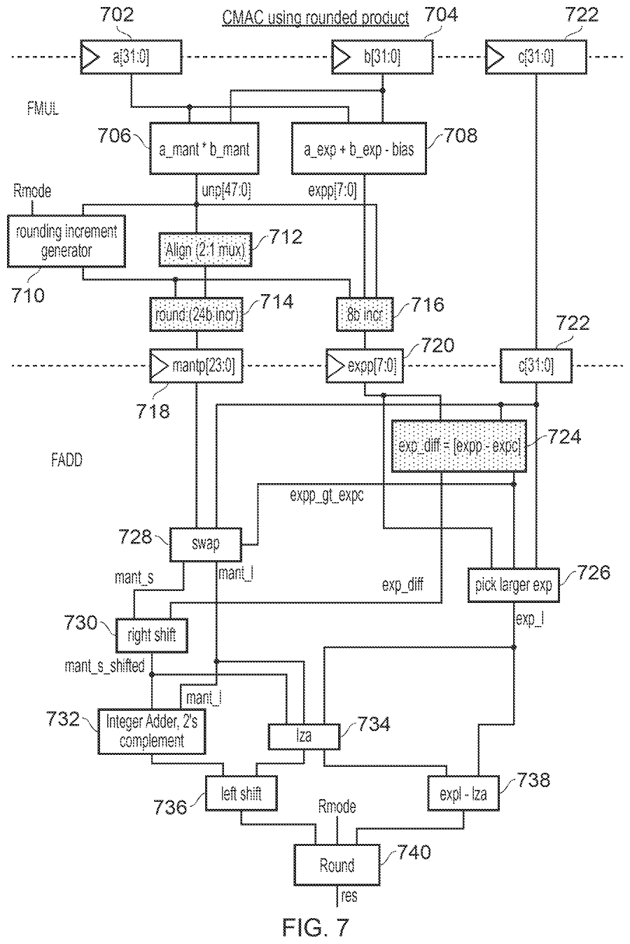

FIG. 7 illustrates the operations performed within an example of a CMAC unit such as the CMAC unit 402 of FIG. 4. As shown in FIG. 7, the FMUL unit takes, as inputs, a first FP (multiplicand) operand 702 and a second FP (multiplicand) operand 704, and is responsible for multiplying these operands together and rounding the generated product. In the FMUL unit, the mantissas of the first and second FP operands (a_mant and b_mant) are multiplied together 706 to generate an unrounded product unp, and the exponents of the first and second FP operands (a_exp and b_exp) are added together and the bias (e.g. the amount by which each of the exponents is biased) is subtracted 708 to generate an associated exponent expp. A rounding increment is then generated 710 based on the unrounded product and a rounding mode (Rmode) selected for the operation, and the unrounded product is aligned 712, before being rounded 714 based on adding the rounding increment to the aligned unrounded product, to generate a rounded product. Note that the alignment of the unrounded product 712 is performed using a 2:1 multiplexer, rather than by performing a shift, as one might expect. This is possible because there are only 2 possible positions for the top 1 bit (e.g. bit 46 or bit 47 in the example of FIG. 7), so the alignment is effectively either a 0 bit or 1 bit shift, which means that the 2:1 multiplexer can select the values to output from unp[47:0], selecting between the two alignment options. The exponent calculated previously is also incremented 716 based on the rounding increment—this is a selective increment, in that it is performed if the top bit was 1, to account for having two leading bits ahead of the binary point, or if the top bit (unp[47]) is 0 but rounding would cause the top bit to be set—this can be predicted without actually doing the rounding, by checking if unp[46:23] is all 1s and the rounding increment bit generated by rounding increment generator 710 is set. A rounded mantissa (mantp) 718 and associated exponent 720 are then supplied to the FADD unit. The rounded mantissa and incremented exponent represent a FP number equivalent to multiplying the first and second FP operands and rounding the result.

The FADD unit takes, as inputs, the rounded mantissa 718 and incremented exponent 720 generated by the FMUL unit, as well as the third FP (addend) operand 722. The FADD unit then generates an exponent difference (exp_diff) 724 between the exponent of the rounded product generated by the FMUL unit and the exponent (expc) of the third FP operand. The larger exponent (exp_l) is then selected 726 for the calculation. The mantissas of the rounded product (mantp) and the third FP operand (mantc) are then swapped 728 if needed, so that the smaller mantissa (manst_s) is right-shifted 730 by a number of places equal to the exponent difference calculated above. The smaller mantissa (mant_s) is also inverted at this stage, if the addition to be performed at the integer adder 732 is an unlike-signed add. This aligns the product and the addend so that they have the same exponent (exp_l), allowing their mantissas to be added 732 by an integer adder. If expp equals expc and the operation was unlike signed, the integer adder 732 could produce a negative result if mantc<mantp—if the result would be negative, the circuit logic 732 also negates the result (e.g. by inverting all bits and adding 1, or by performing an unlike-signed addition with the values being added in the opposite order from the one that would give the negative result). The integer adder relies on negative numbers being written in two's complement form, so that if the addition is an unlike-signed addition (e.g. adding together a negative number and a positive number) the smaller mantissa (mant_s) is converted to two's complement format before the addition. A leading zero anticipator (lza) predicts the number of leading zeroes in the generated result of the MAC operation, and the result is then normalized based on this determination by left-shifting the mantissa 736 by a number of places equal to the number of leading zeroes counted by the lza and adjusting the exponent 738 by subtracting the counted number of leading zeroes. Finally, a second rounding is performed 740 to generate the final result.

As discussed above, this approach requires less circuit area and consumes less dynamic power than an FMAC unit, since the mantissa of the product is rounded and truncated (in this example, to 24 bits) before being added to the mantissa of the third FP operand. However, the MAC operation performed using a CMAC unit can take significantly longer than performing a similar operation using an FMAC unit, because the FADD stage cannot start until the rounding of the product is complete.

It should also be noted that some implementations could choose to support the CMAC circuitry of the present technique and FMAC circuitry, to allow software to choose which to use. For example, the software may choose to use the FMAC for workloads where accuracy is a higher priority than reduced power consumption, and use the CMAC circuitry for other workloads.

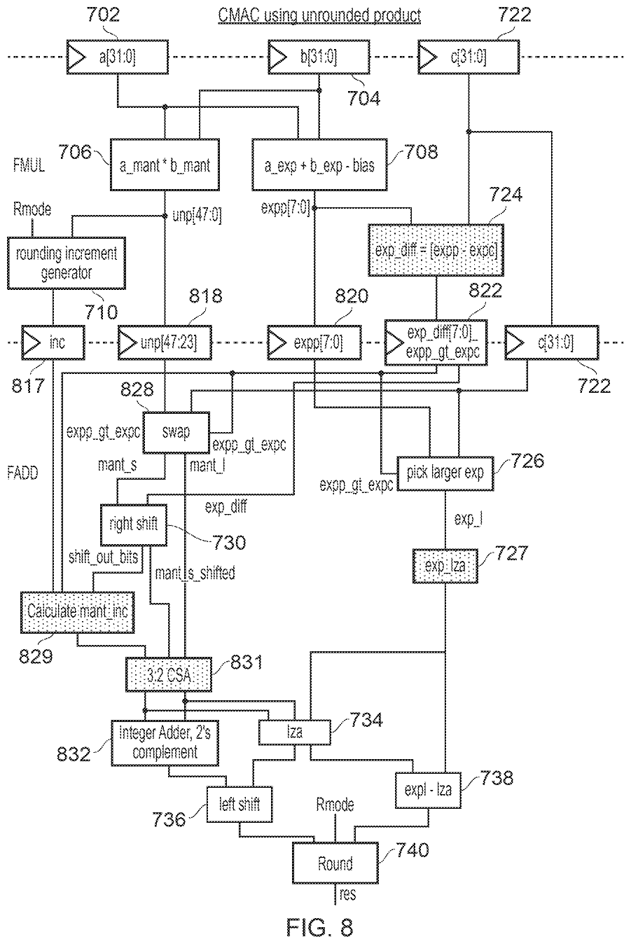

FIG. 8 illustrates the operations performed within an improved CMAC unit such as the CMAC unit 602 shown in FIG. 6. Some differences between the process shown in FIG. 8 and the process shown in FIG. 7 are highlighted by the shaded boxes in each figure. In the process performed by the FMUL unit, the most notable difference is the absence of the align 712 and round 714 steps. While a rounding increment (inc) is still generated 710 in FIG. 8, this is simply provided 817 to the FADD unit, rather than being used to round the product of the multiplication performed by the FMUL unit. Accordingly, an unrounded product (unp) 818 and associated exponent (expp) 820 are provided to the FADD unit, instead of a rounded product and its associated exponent. Note that, despite not being rounded, the product mantissa 818 is nevertheless truncated (e.g. in FIG. 8, the unrounded product is truncated to 25 bits) to avoid the need for wider adders in the FADD stage (as would be the case in an FMA unit, for example). It is acceptable to discard the lower-order bits in this way, since the final result will be equivalent to the first rounding having been done at the FMUL stage. It should further be noted that expp is not incremented during FMUL stage to account for the lack of alignment of the product—even though the unrounded product is not normalized—meaning that the unrounded product may be output with two bits at positions more significant than the binary point.

As a result of removing the lengthy rounding addition 714 (as well as the alignment multiplexer 712) from the FMUL process performed by the FMUL unit, the FMUL process can be made significantly quicker.

In addition, the calculation 724 of the exponent difference and the selection of the greatest exponent are performed much earlier in the multiply-accumulate process, e.g. during the FMUL process, rather than being performed during the FADD process. This also means that the exponent of the addend 722 is provided to the FMUL unit, in addition to the multiplicands 702, 704. This is possible because it is no longer necessary to wait until the exponent of the product is incremented before calculating the difference and selecting the larger exponent. Hence, both of these steps can be moved off the critical path, further reducing the overall time taken to perform the multiply accumulate operation by the CMAC unit.

The FADD unit is then provided with the rounding increment 817, the unrounded product 818 and its associated exponent 820 (not yet incremented to account for the extra bit ahead of the binary point in the unrounded product 818), the exponent difference and an indication of which exponent is larger (expp_gt_expc) 821 and the addend 822.

In the FMUL unit, at or before the swap step 828, a mantissa (mantp) representing the unrounded product is generated, to account for the removal of the 2:1 multiplexer in the FMUL unit. The process of forming mantp will be discussed below.

In addition, since the product generated by the FMUL unit was not rounded, a mantissa increment (mant_inc) needs to be calculated 829 based on the rounding increment, the indication of which exponent is greater, and any bits shifted out in the right shift operation 730. For example, the mantissa increment can be calculated as:

mant_inc[1]=˜lsa & expp_gt_expc & inc & shift_all_zeros

mant_inc[0]=inc & expp_gt_expc & (lsa|˜shift_all_zeros)

|lsa & ˜expp_gt_expc & inc & shift_all_ones

|˜lsa & ˜inc & shift_all_zeros

where lsa is an indication of whether or not the addition performed by the FADD is a “like-signed” add (an addition where both the product and addend are positive or both the product and addend are negative—an addition where one of the product and addend is positive and the other negative being an “unlike-signed” add), and shift_all_ones and shift_all_zeros are set when all the shifted-out bits are ones or zeroes respectively (in the value of the shifted out bits prior to any inversion applied to the smaller operand in the case of an unlike-signed add). A derivation of this expression is provided below. Note that the above expressions calculate bits 1 and 0 of the mantissa increment; bits [24:2] of the mantissa increment are all zero, to pad it to a value with the same width as the other values being added (e.g. the unrounded product and the third FP operand).

Once the mantissa increment mant_inc has been calculated 829, a carry save adder (CSA) can be used to add 831 the unrounded product and the addend (after alignment and possible inversion of mant_s for an unlike-signed add at 730) to the mantissa increment. The CSA generates a sum and a carry value, so an integer adder is then provided as in FIG. 7 to add 832 these values together. The add logic 832 also includes circuitry to optionally negates the result, in the case when a negative result is generated when expp=expc but mantc<mantp. This could be done by inverting the bits of the result and adding one, or by using parallel-prefix integer adders that generate alternative unlike-signed addition results based on both orders of the values being added (e.g. both a-b and b-a) and selecting the one of the alternative results that ends up positive—this can provide a smaller delay than calculating a single result a-b and then performing the 2's complement inversion and increment.

Another difference between the process shown in FIG. 8 and that shown in FIG. 7 is the additional step of incrementing 727 the larger exponent during the FADD stage. This step is included to account for the fact that both the unrounded product and the addend effectively have 2 digits to the left of the binary point (because mantp is un-normalized).

At the end of the process shown in FIG. 8, the result output by the FP multiply-accumulate circuitry (CMAC) is equivalent to the result output by the process shown in FIG. 7. However, by removing the rounding and alignment steps from the FMUL unit and instead modifying the addition performed in the FADD unit, this same result can be achieved more quickly (because alignment of the product and addend at 828, 730 can start without waiting for the first rounding increment, so the critical path length is shortened), allowing the CMAC unit to be employed in situations where timing requirements are tight. In addition, performing the calculation of the exponent difference 724 in the FMUL stage (in parallel with calculation of the unrounded product at 706 and first rounding increment at 710) and removing the increment 727 of the exponent from the critical path (by moving it from the FMUL stage before the exponent difference calculation to the FADD stage after the exponent different calculation 724 and selection of the larger exponent 726) allows the speed of the process to be even further improved.

The example of FIG. 8 does not attempt to handle subnormal values in hardware, and so any subnormal value of one of the operands 702, 704, 722 is flushed to zero, i.e. treated as if it was zero. Similarly, if FMUL stage detects that the intermediate unrounded product represented by unp and expp is too small to represent as a normalised floating-point value in the floating-point format being used, the unrounded product unp[47:0] is set to zero. Also, if the final MAC result res would be subnormal, it is also set to zero. By treating subnormal values as zero, this greatly reduces the complexity of the circuit logic.

Returning to the removal of the 2:1 multiplexer from the FMUL unit, the following explanation is provided.

Instead of having a 2:1 multiplexer (mux) to align the mantissa of the product correctly, we change the initial relative alignment between the mantissas of the product and the addend such that a right shift of the smaller operand by (expp−expc) yields correctly aligned mantissas in all cases.

In particular, the new initial alignment is:
mantp[24:1]=unp[47:24]
mantp[0]=unp[47]?inc:unp[23]
mantc[24:0]={2′b01, opc[22:0]}

The larger exponent (expl) is incremented in FADD cycle (as noted above) to account for this new initial alignment.

Note that mantp[0] is set to “inc” when unp[47]=1 to clear the guard bit and propagate the rounding increment.

This can be better understood by considering the following cases.

Case 1: unp[47]=0

This implies unp[46]=1

The initial alignment is:
mantp[24:0]={2′b01, unp[45:23]}
mantc[24:0]={2′b01, opc[22:0]}

The initial alignment between the mantissas is correct. Shifting by |expp−expc| will correctly align the smaller operand.

Expl is larger by 1. FADD normalization logic will detect the extra leading 0 in the adder result and correct expl.

Case 2: unp[47]=1 and (expp>expc)

Initial alignment is:
mantp[24:0]={1′b1, unp[46:24], inc}
mantc[24:0]={2′b01, opc[22:0]}

The initial alignment between the mantissas is off by 1. We fix this by shifting the smaller operand mantissa mantc by 1 less than the difference in exponents.

Shift amount=Difference in exponents−1

The difference in exponents is ((expp+1)−expc) since expp needs to be incremented to account for unp[47] being set.

Shift amount=expp+1−expc−1=expp−expc

expl is correct since unp[47] is set.

Case 3: unp[47]=1 and (expp<=expc)

Initial alignment is:
mantp[24:0]={1′b1, unp[46:24], inc}
mantc[24:0]={2′b01, opc[22:0]}

The initial alignment between the mantissas is off by 1. We fix this by shifting the smaller operand mantissa mantp by 1 more than the difference in exponents.

Shift amount=Difference in exponents+1

The difference in exponents is (expc−(expp+1)) since expp needs to be incremented to account for unp[47] being set.

Shift amount=expc−expp−1+1=expc−expp

Expl is correct since unp[47] is set.

The shift amount is always |expc−expp| where expp=expa+expb−bias. Since expa, expb and expc are available in FMUL cycle, shift amount can be calculated early to make FADD cycle faster.

Returning to the calculation of the mantissa increment, the following derivation of the expression above is provided. In all cases, the position to add the first rounding increment is the lowest bit of the product mantissa mantp, regardless of whether the product or addend has the smaller exponent. The position to add any two's complement increment in the case of an unlike signed add is the lowest bit of the one of the product/addend with the smaller exponent.

Let L, G, s denote the least-significant bit (lsb), the guard bit and the sticky bit positions.

Case 1: Like-signed add, expp>expc
L_Gsss
mantp: bbbb_bbbb_0000
inc:
shifted mantc: 0000_aaaa_aaaa
Increment with +1 at lsb if inc=1.

Case 2: Like-signed add, expp=<expc
L_Gsss
shifted mantp: 0000_bbbb_bbbb
inc:
mantc: aaaa_aaaa_0000

Increment with +1 at lsb if all shifted out mantp bits are set to ones & inc=1.

Case 3: Unlike-signed add (subtraction), expp>expc
L_Gsss
mantp: bbbb_bbbb_0000
inc:
shifted & inverted mantc: 1111_aaaa_aaaa
2's complement increment for mantc: +1

There are 2 conditions here that can cause an increment at lsb:
1. Inc=1
2. All the inverted & shifted out mantc bits are 1s. This is true when all the shifted-out bits (pre-inversion) bits are 0s.

If both conditions are true, add +2 at lsb, else add +1 at lsb if either condition is true.

Case 4: Unlike-signed add (subtraction), expp=<expc

Since mantp needs to be negated, inc also needs to be negated.
L_Gsss
shifted & inverted mantp: 1111_bbbb_bbbb
2's complement increment for mantp: +1
inc: −1
shifted & inverted mantc: aaaa_aaaa_0000

When i=1, it cancels out the 2's complement increment for mantp.

When i=0, increment with +1 at lsb if all the shifted-out mantp bits (pre-inversion) are 0s.

Combining the 4 cases:
mant_inc[1]=˜lsa & expp_gt_expc & inc & shift_all_zeros//Case3
mant_inc[0]=lsa & expp_gt_expc & inc//Case1
         |lsa & −expp_gt_expc & inc & shift_all_ones//Case2
         |˜lsa & expp_gt_expc & inc & ˜shift_all_zeros//Case3
         |˜lsa & expp_gt_expc & ˜inc & shift_all_zeros//Case3
         |˜lsa &˜expp_gt_expc & ˜inc & shift_all_zeros//Case4

Reducing this expression, we get:
mant_inc[0]=inc & expp_gt_expc & (lsa|˜shift_all_zeros)
         |lsa & ˜expp_gt_expc & inc & shift_all_ones
         |˜lsa & ˜inc & shift_all_zeros

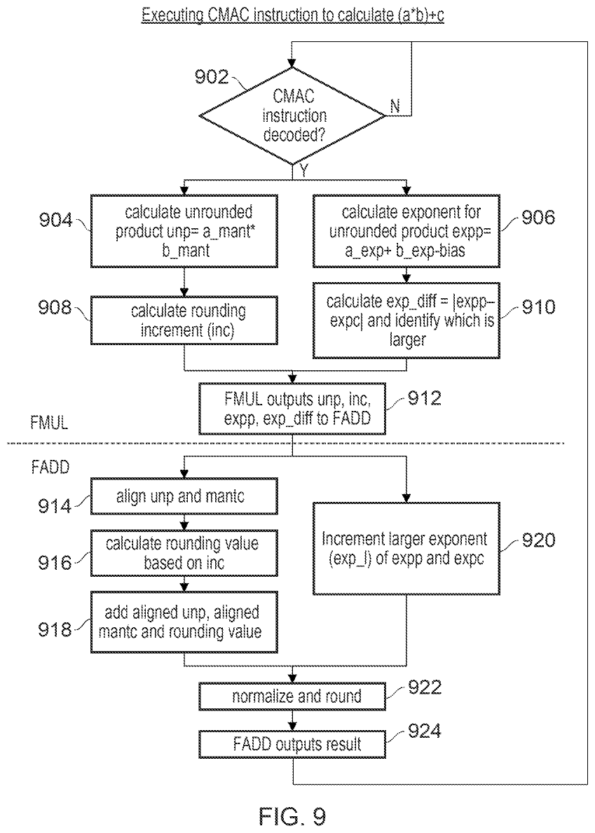

Turning now to FIG. 9, this figure illustrates an example method executed by chained-floating-point-multiply-accumulate (CMAC) circuitry such as the CMAC shown in FIG. 6. In the FMUL unit of the CMAC circuitry, it is determined 902 whether a chained-multiply-accumulate (CMAC) instruction, specifying first, second and third FP operands, has been decoded by an instruction decoder. When it is determined that a CMAC instruction has been decoded (Y), an unrounded product (unp) is calculated 904 by multiplying the mantissas of the first and second FP operands, before calculating 908 a rounding increment (inc) according to the rounding rules for whichever rounding mode (e.g. see Tables 3 and 4 above) is used. Also, an exponent (expp) associated with the unrounded product is calculated 906 by adding the exponents of the first and second FP operands and subtracting the implicit bias. Note that the exponent is not adjusted at this stage to account for any lack of normalized alignment of the unrounded product mantissa. An exponent difference (exp_diff) between the exponent associated with the product (expp) and the exponent of the third FP operand (expc) can then be calculated 910 and the larger of the two exponents can be identified. The FMUL unit then outputs 912, to the FADD unit of the CMAC circuitry, the unrounded product (unp), the rounding increment (inc), the exponent associated with the unrounded product (expp), the exponent difference (exp_diff) and an indication of whether expp or expc is larger.

In the FADD unit, the unrounded product (unp) and the mantissa (mantc) of the third FP operand are aligned 914 (and, if the addition performed in step 918 below is an unlike-signed add, the smaller mantissa of unp and mantc is incremented), and a rounding value (also referred to as a mantissa increment) is calculated 916 based on the rounding increment (inc) (and also based on whether the addition will be a like-signed add or an unlike-signed add, on which exponent is the larger between expp and expc, and on any shifted out bits from the smaller mantissa). The aligned unrounded product and aligned mantissa of the third FP operand can then be added 918 to the calculated rounding value. In addition, the FADD unit also increments the larger exponent (exp_l) of expp and expc. Based on the sum calculated in step 918 and the incremented exponent calculated in step 920, the FADD unit can then create a normalized and rounded result 922, which is output 924.

In this way, the result output by the CMAC unit is equivalent to the result that would be output if a conventional CMAC unit was used. In particular, the result output by the CMAC unit is equivalent to:
1. multiplying the first and second FP numbers to generate a product;
2. rounding the product;
3. adding the rounded product to the third FP operand to generate a sum; and
4. rounding the sum.

The method shown in FIG. 9 therefore allows the advantages of using a CMAC unit—e.g. reduced circuit area and reduced dynamic power consumption when compared with FMA units—to be achieved, while reducing time taken to perform the multiply accumulate operation when compared with conventional CMAC units.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

Examples of the present technique are set out in the following clauses:
(1) An apparatus comprising:
   instruction decode circuitry to decode instructions; and
   processing circuitry to execute the instructions decoded by the instruction decode circuitry,
   wherein the processing circuitry comprises chained-floating-point-multiply-accumulate circuitry responsive to a chained-floating-point-multiply-accumulate instruction decoded by the instruction decoder, the chained-floating-point-multiply-accumulate instruction specifying a first floating-point operand, a second floating-point operand and a third floating-point operand, to:
      generate an unrounded product based on multiplying the first floating-point operand and the second floating-point operand;
      generate a first rounding increment based on the unrounded product;
      generate a sum based on adding the unrounded product, a value based on the first rounding increment, and the third floating-point operand;
      determine a second rounding increment based on the sum; and
      perform rounding based on the second rounding increment.
(2) The apparatus of clause 1, wherein
   the chained-floating-point-multiply-accumulate circuitry is configured to align the unrounded product and the third floating-point operand before generating the sum based on adding the unrounded product, the value based on the first rounding increment, and the third floating-point operand.
(3) The apparatus of clause 2, wherein the chained-floating-point-multiply-accumulate circuitry is configured to:
   generate the unrounded product in an un-normalized form; and
   before aligning the unrounded product and the third floating-point operand, append an additional bit at a most significant end of a mantissa of the third floating-point operand to align a binary point position of the third floating-point operand with a binary point position of the unrounded product.
(4) The apparatus of clause 3, wherein
   the chained-floating-point-multiply-accumulate circuitry is configured to align the unrounded product and the third floating-point operand based on an exponent difference,
   wherein the exponent difference has a value corresponding to
      exponent difference=|a_exp+b_exp−bias−expc/wherein
   a_exp is an exponent of the first floating-point operand, b_exp is an exponent of the second floating point operand, expc is an exponent of the third floating point operand, and bias is an implicit bias applied to each of a_exp, b_exp and expc.
(5) The apparatus of clause 4, wherein the chained-floating-point-multiply-accumulate circuitry is configured to
   increment, after calculating the exponent difference, either the exponent associated with the unrounded product or the exponent of the third floating-point operand.
(6) The apparatus of any preceding clause, wherein the chained-floating-point-multiply-accumulate circuitry is configured to:
   generate the unrounded product in an un-normalized form; and
   generate an exponent difference based on an exponent associated with the unrounded product and an exponent of the third floating-point operand; and
   align the unrounded product and the third floating-point operand based on the exponent difference.
(7) The apparatus of any preceding clause, wherein:
   the chained-floating-point-multiply-accumulate circuitry comprises floating-point-multiply circuitry and floating-point-add circuitry;
   the floating-point-multiply circuitry is configured to generate the unrounded product and generate the first rounding increment; and
   the floating-point-add circuitry is configured to generate the sum based on adding the unrounded product, the value based on the first rounding increment, and the third floating-point operand, determine the second rounding increment and perform the rounding based on the second rounding increment.
(8) The apparatus of clause 7, wherein
   the floating-point-multiply circuitry comprises a first pipeline stage and the floating-point-add circuitry comprises a second pipeline stage subsequent to the first pipeline stage.
(9) The apparatus of clause 8, comprising
   issue circuitry to issue the instructions decoded by the instruction decode circuitry to the processing circuitry for execution,
   wherein when a first instance of the chained-floating-point-multiply-accumulate instruction and a second instance of the chained-floating-point-multiply-accumulate instruction are issued sequentially and input operands specified by the second instance of the chained-floating-point-multiply-accumulate instruction are independent of a result generated in response to the first instance of the chained-floating-point-multiply-accumulate instruction, the floating-point-multiply circuitry is configured to begin processing the second instance of the chained-floating-point-multiply-accumulate instruction while the floating-point-add circuitry is processing the first instance of the chained-floating-point-multiply-accumulate instruction.
(10) The apparatus of any preceding clause, wherein the chained-floating-point-multiply-accumulate circuitry is configured to determine the value based on the first rounding increment in dependence on at least one of:
   whether an exponent associated with the unrounded product is larger than an exponent of the third floating-point operand; and
   whether the sum based on adding the unrounded product, the value based on the first rounding increment, and the third floating-point operand represents a like-signed addition or an unlike-signed addition.
(11) The apparatus of any preceding clause, wherein:
   the chained-floating-point-multiply-accumulate circuitry is configured to align the unrounded product and the third floating-point operand before generating the sum based on adding the unrounded product, the value based on the first rounding increment, and the third floating-point operand; and
   the chained-floating-point-multiply-accumulate circuitry is configured to determine the value based on the first rounding increment in dependence on values of any shifted-out bits shifted, when aligning the unrounded product and the third floating-point operand, to bit positions less significant than a least significant bit position of a result value obtained by performing the rounding based on the second rounding increment.
(12) The apparatus of any preceding clause, wherein
   the chained-floating-point-multiply-accumulate circuitry is configured to select, as the value based on the first rounding increment, one of 0, 1 and 2.
(13) The apparatus of any preceding clause, comprising
   a central processing unit or a graphics processing unit, wherein the central processing unit or the graphics processing unit comprises the processing circuitry.
(14) The apparatus of any preceding clause, wherein
   the chained-floating-point-multiply-accumulate circuitry is configured to truncate the unrounded product before generating the sum.
(15) The apparatus of any preceding clause, wherein:
   the chained-floating-point-multiply-accumulate circuitry comprises a 3:2 carry save adder; and
   the chained-floating-point-multiply-accumulate circuitry is configured to generate the sum using the 3:2 carry save adder.
(16) The apparatus of any preceding clause, wherein
   the chained-floating-point-multiply-accumulate circuitry is configured to output a result value equivalent to generating a product of the first floating-point operand and the second floating-point operand, then rounding the product, then adding the rounded product to the third floating-point operand to generate an unrounded sum, and then rounding of the unrounded sum to generate the result value.
(17) The apparatus of any preceding clause, wherein
   when one or more of the first floating-point operand, the second floating-point operand and the third floating-point operand comprises a sub-normal floating point value, the chained-floating-point-multiply-accumulate circuitry is configured to treat the sub-normal floating point value as zero when processing the chained-floating-point-multiply-accumulate instruction.
(18) The apparatus of any preceding clause, wherein
   the chained-floating-point-multiply-accumulate circuitry is configured to flush the unrounded product or a result value calculated by the chained-floating-point-multiply-accumulate circuitry to zero in response to determining that the unrounded product or the result value is too small to represent as a normalized floating-point number in a floating-point format to be used for the result value.
(19) A method comprising:
   decoding instructions with instruction decode circuitry;
   executing the instructions decoded by the instruction decode circuitry,
   in response to a chained-floating-point-multiply-accumulate instruction decoded by the instruction decoder, the chained-floating-point-multiply-accumulate instruction specifying a first operand, a second operand and a third operand:
      generating an unrounded product based on multiplying the first operand and the second operand;
      generating a first rounding increment based on the unrounded product;
      generating a sum based on adding the unrounded product, a value based on the first rounding increment, and the third operand;
      determining a second rounding increment based on the sum; and
      performing rounding based on the second rounding increment.
(20) A non-transitory computer-readable medium to store computer-readable code for fabrication of an apparatus comprising:
   instruction decode circuitry to decode instructions; and
   processing circuitry to execute the instructions decoded by the instruction decode circuitry,
   wherein the processing circuitry comprises chained-floating-point-multiply-accumulate circuitry responsive to a chained-floating-point-multiply-accumulate instruction decoded by the instruction decoder, the chained-floating-point-multiply-accumulate instruction specifying a first operand, a second operand and a third operand, to:
      generate an unrounded product based on multiplying the first operand and the second operand;
      generate a first rounding increment based on the unrounded product;
      generate a sum based on adding the unrounded product, a value based on the first rounding increment, and the third operand;
      determine a second rounding increment based on the sum; and
   perform rounding based on the second rounding increment.

We claim:

1. An apparatus comprising:
instruction decode circuitry to decode instructions; and
processing circuitry to execute the instructions decoded by the instruction decode circuitry,
wherein the processing circuitry comprises chained-floating-point-multiply-accumulate circuitry responsive to a chained-floating-point-multiply-accumulate instruction decoded by the instruction decoder, the chained-floating-point-multiply-accumulate instruction specifying a first floating-point operand, a second floating-point operand and a third floating-point operand, to:
generate an unrounded product based on multiplying the first floating-point operand and the second floating-point operand;
generate a first rounding increment based on the unrounded product;
generate a sum based on adding the unrounded product, a value based on the first rounding increment, and the third floating-point operand;
determine a second rounding increment based on the sum; and
perform rounding based on the second rounding increment.

2. The apparatus of claim 1, wherein
the chained-floating-point-multiply-accumulate circuitry is configured to align the unrounded product and the third floating-point operand before generating the sum based on adding the unrounded product, the value based on the first rounding increment, and the third floating-point operand.

3. The apparatus of claim 2, wherein the chained-floating-point-multiply-accumulate circuitry is configured to:
generate the unrounded product in an un-normalized form; and
before aligning the unrounded product and the third floating-point operand, append an additional bit at a most significant end of a mantissa of the third floating-point operand to align a binary point position of the third floating-point operand with a binary point position of the unrounded product.

4. The apparatus of claim 3, wherein
the chained-floating-point-multiply-accumulate circuitry is configured to align the unrounded product and the third floating-point operand based on an exponent difference,
wherein the exponent difference has a value corresponding to
exponent difference=|a_exp+b_exp−bias−expc/wherein
wherein a_exp is an exponent of the first floating-point operand, b_exp is an exponent of the second floating point operand, expc is an exponent of the third floating point operand, and bias is an implicit bias applied to each of a_exp, b_exp and expc.

5. The apparatus of claim 4, wherein the chained-floating-point-multiply-accumulate circuitry is configured to
increment, after calculating the exponent difference, either the exponent associated with the unrounded product or the exponent of the third floating-point operand.

6. The apparatus of claim 1, wherein the chained-floating-point-multiply-accumulate circuitry is configured to:
generate the unrounded product in an un-normalized form;
generate an exponent difference based on an exponent associated with the unrounded product and an exponent of the third floating-point operand; and
align the unrounded product and the third floating-point operand based on the exponent difference.

7. The apparatus of claim 1, wherein:
the chained-floating-point-multiply-accumulate circuitry comprises floating-point-multiply circuitry and floating-point-add circuitry;
the floating-point-multiply circuitry is configured to generate the unrounded product and generate the first rounding increment; and
the floating-point-add circuitry is configured to generate the sum based on adding the unrounded product, the value based on the first rounding increment, and the third floating-point operand, determine the second rounding increment and perform the rounding based on the second rounding increment.

8. The apparatus of claim 7, wherein
the floating-point-multiply circuitry comprises a first pipeline stage and the floating-point-add circuitry comprises a second pipeline stage subsequent to the first pipeline stage.

9. The apparatus of claim 8, comprising
issue circuitry to issue the instructions decoded by the instruction decode circuitry to the processing circuitry for execution,
wherein when a first instance of the chained-floating-point-multiply-accumulate instruction and a second instance of the chained-floating-point-multiply-accumulate instruction are issued sequentially and input operands specified by the second instance of the chained-floating-point-multiply-accumulate instruction are independent of a result generated in response to the first instance of the chained-floating-point-multiply-accumulate instruction, the floating-point-multiply circuitry is configured to begin processing the second instance of the chained-floating-point-multiply-accumulate instruction while the floating-point-add circuitry is processing the first instance of the chained-floating-point-multiply-accumulate instruction.

10. The apparatus of claim 1, wherein the chained-floating-point-multiply-accumulate circuitry is configured to determine the value based on the first rounding increment in dependence on at least one of:
whether an exponent associated with the unrounded product is larger than an exponent of the third floating-point operand; and
whether the sum based on adding the unrounded product, the value based on the first rounding increment, and the third floating-point operand represents a like-signed addition or an unlike-signed addition.

11. The apparatus of claim 1, wherein:
the chained-floating-point-multiply-accumulate circuitry is configured to align the unrounded product and the third floating-point operand before generating the sum based on adding the unrounded product, the value based on the first rounding increment, and the third floating-point operand; and
the chained-floating-point-multiply-accumulate circuitry is configured to determine the value based on the first rounding increment in dependence on values of any shifted-out bits shifted, when aligning the unrounded product and the third floating-point operand, to bit positions less significant than a least significant bit position of a result value obtained by performing the rounding based on the second rounding increment.

12. The apparatus of claim 1, wherein
the chained-floating-point-multiply-accumulate circuitry is configured to select, as the value based on the first rounding increment, one of 0, 1 and 2.

13. The apparatus of claim 1, comprising
a central processing unit or a graphics processing unit, wherein the central processing unit or the graphics processing unit comprises the processing circuitry.

14. The apparatus of claim 1, wherein
the chained-floating-point-multiply-accumulate circuitry is configured to truncate the unrounded product before generating the sum.

15. The apparatus of claim 1, wherein:
the chained-floating-point-multiply-accumulate circuitry comprises a 3:2 carry save adder; and
the chained-floating-point-multiply-accumulate circuitry is configured to generate the sum using the 3:2 carry save adder.

16. The apparatus of claim 1, wherein
the chained-floating-point-multiply-accumulate circuitry is configured to output a result value equivalent to generating a product of the first floating-point operand and the second floating-point operand, then rounding the product, then adding the rounded product to the third floating-point operand to generate an unrounded sum, and then rounding of the unrounded sum to generate the result value.

17. The apparatus of claim 1, wherein
when one or more of the first floating-point operand, the second floating-point operand and the third floating-point operand comprises a sub-normal floating point value, the chained-floating-point-multiply-accumulate circuitry is configured to treat the sub-normal floating point value as zero when processing the chained-floating-point-multiply-accumulate instruction.

18. The apparatus of claim 1, wherein
the chained-floating-point-multiply-accumulate circuitry is configured to flush the unrounded product or a result value calculated by the chained-floating-point-multiply-accumulate circuitry to zero in response to determining that the unrounded product or the result value is too small to represent as a normalized floating-point number in a floating-point format to be used for the result value.

19. A method comprising:
decoding instructions with instruction decode circuitry;
executing the instructions decoded by the instruction decode circuitry,
in response to a chained-floating-point-multiply-accumulate instruction decoded by the instruction decoder, the chained-floating-point-multiply-accumulate instruction specifying a first operand, a second operand and a third operand:
generating an unrounded product based on multiplying the first operand and the second operand;
generating a first rounding increment based on the unrounded product;
generating a sum based on adding the unrounded product, a value based on the first rounding increment, and the third operand;
determining a second rounding increment based on the sum; and
performing rounding based on the second rounding increment.

20. A non-transitory computer-readable medium to store computer-readable code for fabrication of an apparatus comprising:
instruction decode circuitry to decode instructions; and
processing circuitry to execute the instructions decoded by the instruction decode circuitry,
wherein the processing circuitry comprises chained-floating-point-multiply-accumulate circuitry responsive to a chained-floating-point-multiply-accumulate instruction decoded by the instruction decoder, the chained-floating-point-multiply-accumulate instruction specifying a first operand, a second operand and a third operand, to:
generate an unrounded product based on multiplying the first operand and the second operand;
generate a first rounding increment based on the unrounded product;
generate a sum based on adding the unrounded product, a value based on the first rounding increment, and the third operand;
determine a second rounding increment based on the sum; and
perform rounding based on the second rounding increment.
